(19) United States
(12) Patent Application Publication
(10) Pub. No.: US 2013/0317791 A1
(43) Pub. Date: Nov. 28, 2013

(54) HYDRODYNAMIC SLUG FLOW MODEL

(71) Applicant: Thomas J. DANIELSON, Katy, TX (US)

(72) Inventor: Thomas J. DANIELSON, Katy, TX (US)

(73) Assignee: CONOCOPHILLIPS COMPANY, Houston, TX (US)

(21) Appl. No.: 13/869,269

(22) Filed: Apr. 24, 2013

Related U.S. Application Data
(60) Provisional application No. 61/638,794, filed on Apr. 26, 2012.

(51) Int. Cl. G06F 17/50

(52) U.S. Cl. CPC G06F 17/5009
USPC 703/2; 703/10

(57) ABSTRACT

A very simple model has been presented which is able to reproduce slug flow from the instability of a flow with average hold-up and slip. The disclosure demonstrates that slug flow may be modeled as two different, stable solutions to the multiphase flow which coexist at different points in the line, moving with a celerity of U_{G}. By using a white-noise inlet condition which preserves the average hold-up in the pipeline, a series of stable slug and stratified regions can be created without any need to resort to a Lagrangian slug tracking scheme. A quite good fit to field data was obtained with minimal effort by adjusting the slip relation. At present, the model merely demonstrates a potential, very attractive, flexible, and easy-to-implement alternative to Lagrangian slug tracking.

### CROSS-REFERENCE TO RELATED APPLICATIONS

This application is a non-provisional application which claims benefit under 35 USC §119(e) to U.S. Provisional Application Ser. No. 61/638,794 filed Apr. 26, 2012, entitled “HYDRODYNAMIC SLUG FLOW MODEL,” which is incorporated herein in its entirety.

### STATEMENT REGARDING FEDERALLY SPONSORED RESEARCH

None.

### FIELD OF THE INVENTION

Hydrodynamic slug flow is the prevailing flow regime in oil production, yet industry still lacks a comprehensive model, based on first principles, which fully describes hydrodynamic slug flow. In one embodiment, a very simple model has been presented which is able to reproduce slug flow from the instability of a flow with average hold-up and slip. The disclosure demonstrates that slug flow may be modeled as two different, stable solutions to the multiphase flow which coexist at different points in the line, moving with a celerity of U_{G}. By using a white-noise inlet condition which preserves the average hold-up in the pipeline, a series of stable slug and stratified regions can be created without any need to resort to a Lagrangian slug tracking scheme. A quite good fit to field data was obtained with minimal effort by adjusting the slip relation. At present, the model merely demonstrates a potential, very attractive, flexible, and easy-to-implement alternative to Lagrangian slug tracking

### BACKGROUND OF THE INVENTION

Multiphase pipe flow, or the flow of two or more phases through a single conduit, is an area of great importance to the oil and gas industry. Oil reservoirs will typically evolve gas at some point in the well tubing, resulting in gas-liquid flow over at least a portion of the well. Often, additional gas is injected at the bottom of the well to lighten the head and increase production, in a process called ‘gas lift’. In gas production, liquid is often produced as a retrograde condensate, i.e., a liquid produced as a result in a drop in pressure or temperature, producing what is called a ‘wet gas’. In addition, water production, either by condensation from saturated gas, or direct production from the reservoir, is an unavoidable aspect of both oil and gas production.

In onshore operations, once the gas-oil-water mixture reaches the well pad, it is directed through a gathering line to a central facility, where it is further processed to remove water and separate the gas from the oil. In an offshore environment, production might be gathered at a subsea manifold and directed to a central platform through an infield line. Often, particularly in deepwater operations, there are significant terrain features between the subsea center and the platform, including the platform riser, which could result in unstable operation. On the platform, the gas-liquid mixture might be separated for pumping and compression, only to be recombined again for multiphase transportation to shore.

While hydrodynamic slug flow is an inherently transient phenomenon, it has historically been modeled as a ‘pseudo steady-state’ which ignores the fundamentally transient nature of the flow. Even in instances where the individual slugs are introduced and tracked in a Lagrangian frame, so-called ‘slug tracking’ (Bendiksen, 1990), the results have been somewhat disappointing, in that the ultimate slug distributions are heavily influenced by user input.

Historically, transient multiphase flow codes grew out of nuclear safety codes developed specifically to model nuclear plants during loss-of-coolant accidents (i.e., steam-water). These codes were heavily augmented by the Oil and Gas industry to deal with the more complex fluids, geometries, and thermodynamics associated with oil and gas production.

Although several attempts were made to develop transient mixture models with a single momentum equation, development settled on two-fluid formulations, employing separate momentum equations for each phase (developed out of a force balance), as the best way forward. While such models were quite successful in simulating hold-up and pressure drop during both steady-state and transient operations, many associated flow assurance issues (e.g., hydrates, hydrodynamic slugs) remain quite rudimentary. Also, the simulators themselves are terrifically slow by general computational fluid dynamics (CFD) standards.

Multiphase flow in pipes is not restricted to the petroleum industry; two- and three-phase flows are encountered in many other engineering applications, e.g., in chemical plants, nuclear plants, and drainage systems. As such, many different engineering disciplines have made important contributions to the state of the art, including petroleum, chemical, nuclear, and civil engineers. In fact, many transient multiphase flow simulators can trace their genesis back to the nuclear industry, where they were developed as ‘nuclear safety codes’ (Micaelli, 1987; RELAP5/MOD1, 1982; TRAC-PF1, 1984)

If one looks up ‘multiphase flow’ in the Chemical Engineers Handbook (Perry and Chilton, 1984), one finds ‘see two-phase flow’. Turning, then, to ‘two-phase flow’, the following reference is found: ‘see flow, two-phase’. Finally, if one turns to ‘flow, two-phase’, one ultimately finds the material, running over approximately 8 pages of heavily empirical correlations, most dating back to the 1950s-1960s. The recommendation for multiphase pipe flow design is to:
Assume that the gas and liquid flow with equal velocities;
Ignore elevation changes;
Assume heat losses are negligible;.

In reality, the gas and liquid never flow at the same velocities—a fact of critical importance when determining the liquid inventory and flow regime in a pipeline. Elevation changes are, in fact, critically important, particularly in wet gas production, where large slip between the gas and liquid can lead to large liquid accumulations on pipeline inclines. Lastly, particularly in long transportation pipelines, heat loss to the ambient surroundings actually drives such processes as paraffin deposition on the pipe wall.

While multiphase flow is not covered in a general undergraduate chemical engineering curriculum, chemical engineers actually possess all of the necessary background to work very effectively in the area. The discipline of multiphase flow modeling, as practiced in Upstream Oil and gas production, typically encompasses:
Fluid mechanics
   1D Navier-Stokes equation
Heat and mass transfer
Thermodynamics
   Equations of State
Phase change
   gas-liquid (condensation, evaporation)
   gas-solid (hydrate formation)
   liquid-solid (wax formation)
Numerical methods
   Discretized PDEs
   Implicit/explicit methods
Reaction
   corrosion

Multiphase flow is a ubiquitous feature of both oil and gas production. Thus, all flow assurance issues occur against the backdrop of multiphase flow. In most instances, a multiphase model must be constructed first, before any assessment of any other flow assurance issue can be treated. In this sense, multiphase flow is a ‘base’ or ‘enabling’ technology—a first requirement in order to properly model and understand all other flow assurance issues.

In many instances, inputs to the flow assurance models must be taken from a multiphase model. One such example is corrosion. Corrosion models often require temperatures, pressures, and shear rates, as well as flow regime—all of which must be produced out of a multiphase hydraulic model. Sand deposition is a strong function of multiphase flow; in inclined regions⁵, liquid flow rates drop, leading to sand bed formation and potential under-deposit corrosion. Carrying capacity of a multiphase flow is also regime-dependent, with slug flow being ideal for sand transportation. In annular flow, sand can be carried in the gas phase at high rates, leading to erosion failures.

In many instances, flow assurance is intimately tied to multiphase flow transients; a classic example of this is hydrate formation. During shutdowns, the pipeline may cool to the hydrate formation temperature. In this case, the line would have to be depressured before hydrates can have a chance to form, to bring the line out of the hydrate formation region. Hydrodynamic slug flow is thought to greatly accelerate the formation of hydrates at the head of the slug. A strong multiphase model is required for kinetic hydrate inhibitors, so that the inhibitor time for each parcel of fluid can be tracked as it moves through the system.

In each instance above, flow assurance prediction and mitigation would be aided by being more fully integrated into a multiphase model. This will require that the multiphase model be developed with an eye towards flow assurance model needs. Chief among these are phase composition, phase temperature, and flow regime.

Nearly all multiphase flow models start with a determination of flow regime. Once the flow regime is known, the appropriate models for liquid hold-up and pressure drop can be determined. Steady-state flow regime is determined from an experimentally constructed flow regime map. Generally, the superficial liquid velocity is plotted against the superficial gas velocity (Mandhane, 1974). For a given pipe diameter and inclination angle, the flow regime is a uniquely determined function of superficial gas and liquid velocities. Transitions from one regime to another are determined by a series of curves, based on a variety of dimensionless parameters. In Beggs & Brill, for example, flow regime transitions are determined from the no-slip liquid hold-up and the Froude number (Beggs & Brill, 1973). A second approach for flow regime determination was outlined by Taitel & Dukler (Taitel and Dukler, 1976). For horizontal or near-horizontal flow, stratified flow is assumed as a base case, then perturbed slightly by introducing an infinitesimal wave to the smooth interface. The flow undergoes a transition from stratified to either slug (H_{L}>0.5) or annular (H_{L}<0.5) flow. The Taitel-Dukler criterion has proved fairly accurate against low-pressure, air-water data, but does not capture the stratified-slug boundary accurately for higher pressures (Taitel and Dukler, 1990). The OLGA® transient program selects flow regime based upon the so-called ‘minimum slip’ criterion. For a given pressure drop, OLGA® selects the flow regime which gives the lowest difference between the gas and liquid linear velocities—hence, ‘minimum slip’. The minimum slip condition also corresponds to the regime which gives the lowest liquid hold-up for a given pressure drop (Erickson and Mai, 1992). While the minimum slip criteria has proven quite accurate at high pressures, there is evidence to suggest that it does not accurately capture flow regime when benchmarked against low-pressure, air-water data, or for data with significant negative inclinations.

Transient two-phase flow is incredibly complex. A quick review of two-phase flow using the Buckingham Pi Theorem (Buckingham, 1914) requires 10 variables including U_{SG}, U_{SL}, ρ_{G}, ρ_{L}, μ_{G}, μ_{L}, σ, D, θ, ε, P, T and 3 dimensions including L, M, and T. This gives a total of 7 dimensionless groups possible. This large number of dimensionless groups points to the inherent complexity of the phenomenon. In order to build a comprehensive, general purpose transient model, it must be able to seamlessly handle all possible flow regimes, pipe diameters and inclinations, and gas and liquid rates, including both single-phase gas and single-phase liquid flows. Phases can appear and disappear. Flow regimes can and do change in both time and space. It is a tribute to the complexity and difficulty of transient multiphase flow that so few transient models exist. Water is involved in hydrate formation, corrosion, and scale—all relevant to the production of oil and gas. As such, the water phase must be specifically accounted for in any transient scheme used for oil and gas production. Unfortunately for the modeler, the presence of a third phase complicates the models considerably. Repeating the Pi theorem for 3-phase flow gives 12 separate dimensionless groups. This very large number of dimensionless groups points to the large amount of overall complexity present in multiphase flow as compared to single-phase flow, which is completely governed by two dimensionless groups (the Reynolds number and the relative pipe roughness). For many years, the OLGA® code specifically tracked water in the mass equation, but lumped water and oil together in the momentum equation. This is ‘almost always’ good enough to handle most situations of relevance for flow assurance'; however, there are phenomena which cannot be captured (for example, oil/water slugging) which require that water have its own momentum equation. Both OLGA® and LEDAFlow® transient multiphase codes currently employ separate momentum equations for water (Danielson, 2007). Traditional, correlational approaches to multiphase flow would add multiple moment phases together to produce a steady-state mixture momentum equation that includes water, gas, and oil momentum equations.

Once the flow regime is determined, empirical models are employed for determination of hold-up first, and then pressure drop. It is worth noting once the momentum equations are totaled in this way, one must provide additional closures to obtain the hold-up. This is the fundamental difference between two-fluid, mechanistic models and empirical correlational methods. Unfortunately, the two approaches are fundamentally the same and have similar faults and computational requirements.

In the LEDAFlow® transient simulator, energy equations are carried for each phase. This results in quite different transient thermal behavior that occurs for models with a single energy equation, e.g., OLGA®. For example, during shutdown/cooldown transients for deepwater platforms with long (<1 km) risers using LEDAFlow®, the gas phase in the riser gets considerably colder than in the identical case run with OLGA®. This is due to the fact that the single-energy equation approach takes a weighted average of the gas and liquid thermal densities. Thus, anywhere there is even a small amount of liquid present, it tends to alter the Joule-Thompson cooling characteristics, and thus the temperature transient behavior, of the gas-liquid mixture. Given that cold gas in the presence of water can result in hydrate formation, either during shutdown or just after restart, this suggests that a single-equation, mixture-energy approach may be inadequate from a flow assurance point of view.

All transient multiphase models are semi-empirical in nature, in that they start from first principles with conservation laws for mass, momentum, and energy as above, but rely on a number of empirical ‘closure’ relationships to solve for the ψ, ΣF, and Q terms in the momentum and energy balance equations. For example, calculation of ψ is often done from a look-up table derived from a thermodynamic equation of state—usually the Suave-Redlich-Kwong or Peng-Robinson equation, which closes the mass conservation equations (Van Ness and Abbott, 1982). The heat loss term Q is calculated from a volume-averaged Dittus-Boelter correlation, which closes the energy conservation equations (Kreith and Black, 1980).

A word should be said here. The approach of using look-up tables for fluid properties, while not strictly correct in a transient model, allowed for transient calculations to be done in a reasonable amount of time on computers that were available in the 1980s. Even though computers are considerably faster now, even today nearly all transient multiphase calculations performed by the industry are done using a property look-up table. It is the author's view that while look-up tables were a very clever stop-gap measure that was—at one time—necessary, the concept has probably outlived its usefulness. The oil and gas industry needs to move on to routinely using a compositional-tracking approach. This will become increasingly important as flow assurance models are integrated directly into transient multiphase models.

In order to close the momentum equations above and arrive at a solution, one must provide closure relationships for the force terms. Because of the heavily empirical nature of the force closures, large numbers of experiments must be performed over an extensive range of flow rates, fluid properties, and inclination angles. Generally, experimental equipment available in university laboratories are limited to air-water experiments at near-atmospheric conditions in 1-2 inch pipe; this severely limits the scalability of the models produced. The OLGA® and LEDAFlow® codes are based largely on data taken in the Tiller flow loop, an 8-inch line at −1°, ½°, 0°, ½°, 1°, and 90° inclines, operated at pressures up to 90 bar, with three different hydrocarbon liquids spanning 2 orders of magnitude in viscosity.

Care is taken in the laboratory experiments to assure that momentum forces are negligible. By simplifying the momentum equations, a simplified multiphase ‘point model’ is generated. The point model forms the basis for all multiphase models, steady-state and transient. There are many drawbacks in the two-fluid, two-momentum equations approach. First, the interfacial shear stress term τ₁ cannot be measured directly, even in principle. Second, the interfacial surface area S₁ is difficult to define except for the degenerate case of stratified-smooth flow in horizontal pipe. In many situations of practical interest, for example stratified-mist flow, the hold-up is a continuous function of position, and there is no clear interface. In slug flow, the force balance equations can only be solved in an averaged sense. Lastly, in the two-fluid formulation, the gas and liquid velocities can become unbounded as H_{L} approaches 0 or 1.

Steady-state correlational models such as Beggs and Brill have the advantage that they are based on parameters which are easy to measure, e.g., the superficial gas and liquid velocities, but which are difficult to relate to a force balance. Mechanistic models, such as the two-fluid model—since they derive more directly from first principles—are generally believed to extrapolate better to conditions far from where the model was benchmarked (although there is no strong evidence that this is the case). However, they involve terms such as the ‘interfacial friction factor’, which cannot be measured directly, and must be inferred from the experimental data.

It is also not at all clear that the ‘flow regime’ is a useful concept from a modeling standpoint. The presence of multiple flow regimes greatly complicates the formulation of a transient multiphase model. For example, there may be discontinuities in both hold-up and pressure drop across flow regime boundaries (a non-issue in steady-state codes) which could introduce numerical instabilities or convergence problems in the transient code. While the details are impossible to enumerate here, the general idea advocated here is to develop a regime-free approach in the multiphase point model. This could be done by, for example, expand the ‘drift-flux’ model so that it can be used for stratified and annular flow regimes, as well as slug and bubble flow. In fact, some progress has been made along these lines (Danielson and Fan, 2009).

Various factors contributing to the motion of the bubbles in two-phase flow have been presented including the ‘drift-flux’ relation (Nicklin, 1962). Unfortunately, the drift-flux model fails at low liquid superficial velocities (see e.g. Danielson and Fan 2009). Patankar and Joseph solve the fluid phase continuity and momentum equations on an Eulerian grid (Patankar and Joseph, 2001), including the use of a power-law upwinding scheme to provide a first-order discretization in computational space for a convection-diffusion problem (Patankar 1980). In general from experiments in hydrodynamic slug flow it has been determined that typical hydrodynamic slug lengths, on average, are around 30 diameters (Manolis et al., 1998). The intermediate value theorem simply demonstrates that given two points on either side of a continuous function at one point going from the first point to the second point must be a solution to the function (Shenk, 1979).

Because of the large amount of sub-grid calculations that a transient multiphase flow simulator must make, compared to a general CFD code, the performance of transient multiphase flow codes is quite slow by comparison. OLGA® and LEDAFlow® are typically run using several hundred to perhaps a thousand grid points, running at perhaps 50× real time—the limit of acceptability for on-line, look-ahead systems (Danielson, et al., 2011). This is very slow, given the extremely coarse grids (with segment L/D ratios in the 100 s to 1000 s). This performance is accepted because the industry has become accustomed to this as typical performance. If the multiphase models were simplified and streamlined, significant speed increases could be achieved, allowing for much finer grids.

In the future, simple, powerful mixture models may well make a comeback, supplanting the more complex two-fluid models. The rationale is three fold: First, the simplicity of these models will allow much greater computational speed, resulting in the possibility to run much finer grids (on the order of a pipeline diameter) than currently used by transient pipeline simulators. Second, compositional tracking could be routinely used, allowing for much simpler simulations of, for example, complex networks of differing fluids. Third, flow assurance phenomena such as hydrate formation could be folded directly into the multiphase model on a fundamental level, rather than as an ad hoc addition.

### BRIEF SUMMARY OF THE DISCLOSURE

The disclosure describes a very simple, time-dependent, two-phase (gas-liquid) model which is capable of producing hydrodynamic slugging from first principles. The model is able to reproduce slug flow from the instability of a flow with average hold-up and slip. The disclosure demonstrates that slug flow may be modeled as two different, stable solutions to the multiphase flow which coexist at different points in the line, moving with a celerity of U_{G}. By using a white-noise inlet condition which preserves the average hold-up in the pipeline, a series of stable slug and stratified regions can be created without any need to resort to a Lagrangian slug tracking scheme. A quite good fit to field data was obtained with minimal effort by adjusting the slip relation. At present, the model merely demonstrates a potential, very attractive, flexible, and easy-to-implement alternative to Lagrangian slug tracking

The new method can be applied for evaluation of slugging potential for oil pipelines. The model is capable of producing slug lengths and frequencies, as well as slug hold-ups. The model has been compared to actual data, including the published Prudhoe Bay field data gathered by Brill, et al. (1981). The model has been able to predict the transition from homogeneous to slug flow, as well as provide information about slug lengths and frequencies. Such a simple model provides a platform for building more complex models capable of predicting slug distributions from first principles without additional user input. No such model currently exists.

In one embodiment, a system for determining flow assurance is described where a computer readable medium comprising one or more modeling programs, providing properties for one or more sections of a pipe comprising a composition with two or more phases, developing a point model for at least one section of pipe given a set of physical properties for each phase present in said section of pipe, connecting one or more additional sections of pipe to develop a steady-state model for a pipeline, and incorporating the steady-state model into a transient scheme for modeling slug flow.

In another embodiment, a method of determining flow assurance is demonstrated by providing properties for one or more sections of a pipe comprising a composition with two or more phases, developing a point model for at least one section of pipe given a set of physical properties for each phase present in said section of pipe, connecting one or more additional sections of pipe to develop a steady-state model for a pipeline, and incorporating the steady-state model into a transient scheme for modeling slug flow.

In yet another embodiment, a method of producing hydrocarbon containing mixtures from a subterranean formation where providing properties for one or more sections of a pipe comprising a composition with two or more phases, developing a point model for at least one section of pipe given a set of physical properties for each phase present in said section of pipe, connecting one or more additional sections of pipe to develop a steady-state model for a pipeline, incorporating the steady-state model into a transient scheme for modeling slug flow, and providing a flow assurance model that provides conditions for producing hydrocarbon containing mixtures from as subterranean formation without slug formation or flow impediments.

In another embodiment the multiphase flow may be conducted and/or modeled using one or more commercially available software programs including ANSYS™, EOSMODEL™, GASVLE™, OILVLE™, HYSYS™, LEDAFLOW®, MULTIFLASH®, NATASHA™, NODEMODEL™, OLGA®, PIPEFLO™, PIPELINE STUDIO™, PIPESIM™, PIPESYS™, PVTSIM™, REO®, WAXPRO™, XPLORE™ and the like, or may use a custom or in-house software written to model multiphase flow in a pipeline.

Physical parameters may include physical properties measured or calculated such as gas temperature (T_{G}), liquid temperature (T_{L}), pipe cross-sectional area (A), gas cross-sectional area (A_{G}), liquid cross-sectional area (A_{L}), total volumetric flow rate (Q), gas volumetric flow rate (Q_{G}), liquid volumetric flow rate (Q_{L}), gas mass fraction (ψ), fixed-frame linear liquid velocity in the slug body (U_{B}), moving-frame linear liquid velocity in the slug body (U_{B}'), gas linear velocity (U_{G}), liquid linear velocity (U_{L}), mixture velocity (U_{M}), drift velocity (U_{O}), slip velocity (U_{S}), fixed frame superficial liquid velocity in the slug body (U_{SB}), moving frame superficial liquid velocity in the slug body (U_{SB}'), gas superficial velocity (U_{SG}), liquid superficial velocity (U_{SL}), fixed-frame superficial liquid velocity in the stratified region (U_{SS}), moving-frame superficial liquid velocity in the stratified region (U_{SS}′), or other property associated with the pipeline, the composition, or one or more phases in the composition.

The point model may include a steady state equation where:

U_{S}H_{L}²+(U_{M}−U_{S})H_{L}−U_{SL}=0

Slug formation may be predicted through slug propagation:

δz·d(H_{L})/dt=(U_{SL})_{IN}−(U_{SL})_{OUT}=(U_{SL}′+U_{G}·H_{L})_{IN}−(U_{SL}′+U_{G}·H_{L})_{OUT} and ((U_{SL}′+U_{G}·H_{L})_{IN}−(U_{SL}′+U_{G}·H_{L})_{OUT}=(U_{SL}′)_{IN}−(U_{SL}′)_{OUT}+(U_{G}·H_{L})_{IN}−(U_{G}·H_{L})_{OUT}.

### BRIEF DESCRIPTION OF THE DRAWINGS

A more complete understanding of the present invention and benefits thereof may be acquired by referring to the follow description taken in conjunction with the accompanying drawings in which:

FIG. 1: Plot of F(H_{L}) vs. H_{L}. Each point where the curve crosses the x-axis (hold-up axis) is a solution to the hold-up equation. Note that, for a constant U_{M}=4 m/s, at U_{SL}=1 m/s (U_{SG}=3 m/s), there is only one low-hold-up solution; this solution is considered to be stratified flow. At U_{SL}=3 m/s, there is only one high-hold-up solution; this solution is considered bubble flow. At intermediate U_{SL}s, including U_{SL}=2 m/s, there are three separate solutions for hold-up. The middle solution is unstable, but the low- and high-hold-up solutions are both stable and thus both physically realizable simultaneously; this is slug flow.

FIG. 2: Plot of stratified and bubble regions of slug flow, shown in two different reference frames. In a reference frame which moves forward with the gas bubble in the stratified region of the flow, the superficial velocities in the stratified and bubble regions of the flow become equal. The hold-up function F(H_{L}) is formulated in this moving reference frame.

FIG. 3: Plot of slug model for periodic boundary conditions, i.e., any slug which leaves the domain on the right-hand side is reintroduced on the left-hand side. The liquid hold-up is initialized to a stratified flow with (U_{SL}, U_{SG})=(1 m/s, 3 m/s), H_{L}=0.4. The slip function used was U_{S}(H_{L})=−4·H_{L}+4. Over time, a small perturbation of the hold-up grows into a slug. This slug continues to grow until it encompasses all the liquid above the stratified hold-up of H_{L}=0.27.

FIG. 4: Plot of slug model for a randomized inlet liquid hold-up which ranges linearly between H_{L}=[0, 0.8] for the once-through pipeline model (i.e., liquid enters at the left-hand side and exit at the right-hand side). Liquid slugs are created as waves at the gas-liquid interface bridge the pipe. These slugs continue to merge and grow as they move across the 1000 m domain.

FIG. 5: Plot of slug model for a periodic boundary condition, using the final state of the once-through model (FIG. 4). Here the slugs have all grown and merged to a stable configuration which is longer changing. The longest slugs are around 30 diameters long, in keeping with experimental findings for hydrodynamic slug flow.

FIG. 6: Plot of slug model with U_{S}(H_{L})=4·H_{L}−4, or the negative of what was used before. This change is meant to represent behavior in a declined section, where the liquid moves faster than the gas. Here, the slugs have lost stability and collapsed back to what appear like rolling waves with an average hold-up H_{L}=0.4.

FIG. 7: Plot of hold-up vs distance for a field line. Note that the slugs continue to evolve as they move through the pipeline. The model is adjusted to keep the hold-up in the slug body at H_{L}=0.6, as per the measurement. A white noise signal is used at the inlet of the pipeline.

FIG. 8: Plot of liquid hold-up exiting the pipeline at 4500 m. Slug sizes in the simulation range from 45 to 750 meters; field measurements for slug length varied from 30 to 430 m.

FIG. 9: histogram of number of instances of slugs plotted versus slug size. Median slug size is in the 100-150 m bin—in good agreement with the slug measurement of 120 m. The largest slug observed in testing was 430 m, which is around half of that produced by the simulation (roughly 10 times as many slugs observed). This discrepancy may be due to the much larger number of observations that were done in the numerical simulation, allowing for the observation of rarer, larger slugs.

FIG. 10: This figure demonstrates how only selected hold-ups lead to instability, as indicated by the F(H_{L}) function. Hold-ups which occur for negative slopes of F(H_{L}) give stable behavior, and hold-ups which occur for positive F(H_{L}) give unstable behavior. Thus, the behavior of this simple model reflects how actual multiphase flows behave.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

Flow assurance can be defined as any issue arising in the production system between the reservoir and the central facility which has the potential to impede production. This could include:
Phase Change
   Hydrates
   Paraffin
Precipitation
   Scale
   Asphaltenes
Reaction
   Corrosion
Solids
   Production fines
   Hydrate crystals
   Wax particles

‘Flow assurance’ is in fact a well known term covering all the issues mentioned above. ‘Determining flow assurance’ as used herein thus means determining the likelihood of occurrence of any one of a number of undesirable issues connected with multiphase pipeline flow and/or estimating or calculating the extent of any such issue. The issues involved are well known in the oil and gas technical field, but include specifically the issues mentioned in the previous paragraph. In other words, ‘Determining flow assurance’ can mean determining the likelihood (risk) of any of the following and/or estimating or calculating the extent of any of the following: pipeline or other corrosion or erosion, hydrate formation or paraffin formation (e.g. resulting from phase change), sand deposition, generation or deposition of production fines, hydrate crystals or wax particles, precipitation of scale or asphaltenes, or combinations of any of these issues (e.g. erosion due to deposited sand.)

In addition, there are flow assurance issues that result explicitly from multiphase flow itself These would include:
Terrain or riser slugging
Ramp up slugs
Pigging/sphering slugs

One of the defining characteristics of multiphase flow is the presence of a definitive flow regime, understood as the large-scale variation in the physical distribution of the flowing gas and liquid phases in a flow conduit. Multiphase pipe flow is generally considered to fall into one of four basic regimes:
stratified flow: a continuous liquid stream flowing at the bottom of the pipe, with a continuous stream of gas flowing over; stratified-wavy flow is sometimes differentiated from stratified smooth flow.
slug flow: stratified flow, punctuated by slugs of highly turbulent liquid. Plug flow is a form of slug flow that occurs at lower velocities.
annular flow: a thin liquid film adhering to the pipe wall, and a gas stream containing entrained liquid droplets.
bubble flow: a continuous liquid flow with entrained gas bubbles.

### Nomenclature

A=pipe cross-sectional area (m²)

A, B, C=parameters in the slip equation (−)

A_{G}=gas cross-sectional area (m²)

A_{L}=liquid cross-sectional area (m²)

C_{DF}=constant derived from the drift-flux model (−)

C_{O}=flux parameter in the drift-flux model (−)

H_{B}=hold-up in the slug region (−)

H_{G}=gas hold-up (−)

H_{L}=liquid hold-up (−)

H_{S}=hold-up in the stratified region (−)

Q=total volumetric flow rate (m³/s)

Q_{G}=gas volumetric flow rate (m³/s)

Q_{L}=liquid volumetric flow rate (m³/s)

Ψ=gas mass fraction (−)

U_{R}=fixed-frame linear liquid velocity in the slug body (m/s)

U_{R}′=moving-frame linear liquid velocity in the slug body (m/s)

U_{G}=gas linear velocity (m/s)

U_{L}=liquid linear velocity (m/s)

U_{M}=mixture velocity (m/s)

U_{O}=drift velocity in the drift-flux model (m/s)

U_{S}=slip velocity (m/s)

U_{SB}=fixed frame superficial liquid velocity in the slug body (m/s)

U_{SB}′=moving frame superficial liquid velocity in the slug body (m/s)

U_{SG}=gas superficial velocity (m/s)

U_{SL}=liquid superficial velocity (m/s)

U_{SS}=fixed-frame superficial liquid velocity in the stratified region(m/s)

U_{SS}′=moving-frame superficial liquid velocity in the stratified region (m/s)

In one embodiment, the disclosure provides a novel approach to slug flow modeling where the fundamental transient nature of hydrodynamic slug flow is accounted for in the model. The momentum equations in the transient multiphase model are greatly simplified by using a single momentum equation with inertial terms removed for the gas-liquid mixture. The momentum equation is used to obtain the pressure profile, which is—in turn—used to find the mixture velocity. It is critical that the multiphase mixture model be regime-free, with a single, correlational approach, along the lines of a drift-flux model, used to obtain the hold-up and pressure drop across the board. Using a single momentum equation with multiple energy equations provides an accurate and rapid model with reduced computational requirements. From a flow assurance perspective, it is important to track the temperatures of each phase. Temperature differences between phases can deviate significantly from mixture energy models, particularly during transient operations such as shutdown/restart. Computing speeds have reached a point now where it is practical and effective to use a pure compositional tracking approach in transient multiphase flow. While look-up tables for fluid properties were—at one time—required to give reasonable simulation times, a more accurate assessment of flow assurance and fluid properties can be obtained by using a more detailed model.

In order to formulate a model for slug flow, we must first develop a ‘point model’ for an individual pipeline segment, or computational cell, in a pipeline. This pipeline segment must then be joined with other pipeline segments upstream and downstream of it to form a ‘steady-state’ model for the pipeline. Lastly, these steady-state solutions must be implemented into a transient scheme; a proper model of hydrodynamic slug flow absolutely requires that slugging not be treated as a pseudo-steady-state, but as an inherently transient phenomenon.
First, we must define some terms. The gas and liquid hold-ups are defined by:

H_{G}≡A_{G}/A; H_{L}≡A_{L}/A; H_{G}+H_{L}=1
The superficial gas and liquid velocities are defined by:
   U_{SG}≡Q_{G}/A; U_{SL}≡Q_{L}/A; U_{M}≡U_{SG}+U_{SL}
The actual linear velocities are related to the superficial velocities by:

U_{L}≡U_{SL}/H_{L}; U_{G}≡H_{SG}/H_{G}
The velocity difference, or slip velocity, between the gas and the liquid is defined as

U_{S}≡U_{G}−U_{L}≡U_{SG}/H_{G}−U_{SL}/H_{L}≡U_{SG}/(1−H_{L})−U_{SL}/H_{L}
This equation can be rearranged to give an equation in hold-up:

U_{S}H_{L}²+(U_{M}−U_{S})H_{L}−U_{SL}≡0
Another way of writing the hold-up equation is as follows:

R(U_{L})≡U_{S}H_{L}²+(U_{M}−U_{S})H_{L}−U_{SL}
The zeros of this hold-up function F(H_{L}*)=0 are solutions to the holdup equation, or the ‘steady-state’ solution to the multiphase flow. For a constant slip velocity U_{S}, the hold-up equation is quadratic and can easily be solved analytically. If the slip velocity is a function of the hold-up, i.e.,

U_{S}=U_{S}(H_{L})

It is quite likely that there is no analytic solution to this equation, and it must be solved numerically. Regardless of the functional form of U_{S}(H_{L}), if the superficial gas and liquid velocities are both positive, then there is always at least one physically-realizable (i.e., 0≦H_{L}≦1) solution to the equation. This can be seen by examining F(H_{L}) at the limits of H_{L}=0 and H_{L}=1; since F(H_{L}=0)=−U_{SL}<0, and F(H_{L}=1)=U_{SG}>0, there must be some point 0<H_{L}*<1 which satisfies the equation F(H_{L}*)=0. The existence of at least one solution for 0<H_{L}<1 can be demonstrated mathematically and hold-up H_{L}* provides a steady-state solution for the hold-up equation.

With simpler, regime-free transient multiphase models there is the possibility of folding other flow assurance models directly into the transient simulator without negatively impacting required simulation time. One example is combining a slug capturing model with a kinetic hydrate formation model.

The following examples of certain embodiments of the invention are given. Each example is provided by way of explanation of the invention, one of many embodiments of the invention, and the following examples should not be read to limit, or define, the scope of the invention.

### EXAMPLE 1

### Stability Analysis

The stability of these ‘steady-state’ solutions can be examined through the application of mass conservation for a particular point in the pipeline. The mass conservation equation for the liquid phase is given by:

d(ρ_{L} δz·A·H_{L})/dt=(ρ_{L}·A·U_{SL})_{IN}−(ρ_{L}·A·U_{SL})_{OUT}

If the liquid density, pipe cross-sectional area, and section length are constant, this simplifies to a volume conservation equation:

δz·d(H_{L})/dt=(U_{SL})IN−(U_{SL})_{OUT}

Consider a single cell, with a constant inlet superficial velocity (U_{SL})_{IN}, with (U_{SL})_{OUT} as a function of the hold-up in that cell:

U_{SL}(H_{L})≡U_{S}(H_{L})H_{L}²+(U_{M}−U_{S}(H_{L}))H_{L}

Note that the hold-up equation is used not to determine the hold-up from the superficial velocities and the slip velocity; now the superficial velocity is determined from the hold-up, the slip velocity, and the mixture velocity. The volume conservation equation can be written as:

δz·d(H_{L})/dt=U_{SL}−[hd S(H_{L})H_{L}²+(U_{M}−U_{S}(H_{L}))H_{L}]=−F(H_{L})

Let H_{L}* be a zero of F(H_{L}) and therefore a solution to the hold-up equation. Then, if

[d(F(H_{L}))/dH_{L}]_{HL=HL*}>0

the steady-state solution H_{L}* is stable, and the transient equation will migrate to the steady-state hold-up H_{L}* and remain there. Likewise, if

[d(F(H_{L}))/dH_{L}]_{HL=HL*}<0

the steady-state solution H_{L}* is unstable, and the transient equation will migrate away from the steady-state hold-up. From a graphical point of view, if F(H_{L}) crosses the hold-up axis (H_{L}=H_{L}*) with a positive slope, then the solution is stable; if F(H_{L}) crosses the hold-up axis with a negative slope, then the solution is unstable.

### EXAMPLE 2

### Multiple Solutions

Of course, it is entirely possible that the hold-up function F(H_{L}) can cross the hold-up axis at more than one point, i.e., F(H_{L}) can have more than 1 physically-realizable solution. In fact, if F(H_{L}) is a continuous function of H_{L}, any odd solutions is at least topologically possible (even numbers of crossings are not possible if U_{SL}, U_{SG}>0).

If the slip velocity U_{S} is constant, then F(H_{L}) is quadratic in hold-up. Since a quadratic equation can only have, at most—2 real roots, there can only be a single crossing between 0<H_{L}<1, since F(H_{L}=0)<0 and F(H_{L}=1)>0.

Hydrodynamic slug flow is characterized by high-hold-up slugs of liquid with little slip between the gas and liquid phases separated by low-hold-up stratified regions characterized by high slip between the phases. The gas bubble in the separated region travels at a characteristic speed U_{G} which can be related to mixture velocity via a ‘drift-flux’ relation:

U_{G}=C_{O}·U_{M}+U_{O}

The slip velocity is given by:

U_{S}=(U_{G}−U_{M})/H_{L}=[(C_{O}−1)U_{M}+U_{O}]/H_{L}

Since U_{M} is constant in incompressible slug flow, this has the form

U_{S}=C_{DF}/H_{L}

where C_{DF} is a constant for constant U_{M}. The hold-up function then becomes

F(H_{L})=(U_{M}+C_{DF})H_{L}−(U_{SL}+C_{DF})

Note that the drift-flux model exhibits a fundamentally wrong behavior in the limit of H_{L}=0, as F(H_{L}=0)=−U_{SL}, and should not be used at low U_{SL}s. The drift-flux model is, however, stable for all steady-state hold-ups (as U_{M}+C_{DF}>0 everywhere).

This finding also implies that detailed transient modeling of slug flow, including growth, merging, and disappearance of slugs using the drift flux approach under these conditions is simply not possible. Thus, the drift-flux model, while giving an excellent average picture of the average hold-up, is not the proper starting point for any kind of transient analysis of hydrodynamic slug flow.

Let us consider the following form for the slip velocity Uₛ(H_{L}):

U_{S}(H_{L})=A·H_{L}+B

Introducing this into the hold-up function F(H_{L}), we obtain the following:

F(H_{L})=A·H_{L}³+(B−A)·H_{L}²+(U_{M}−B)·H_{L}−U_{SL}

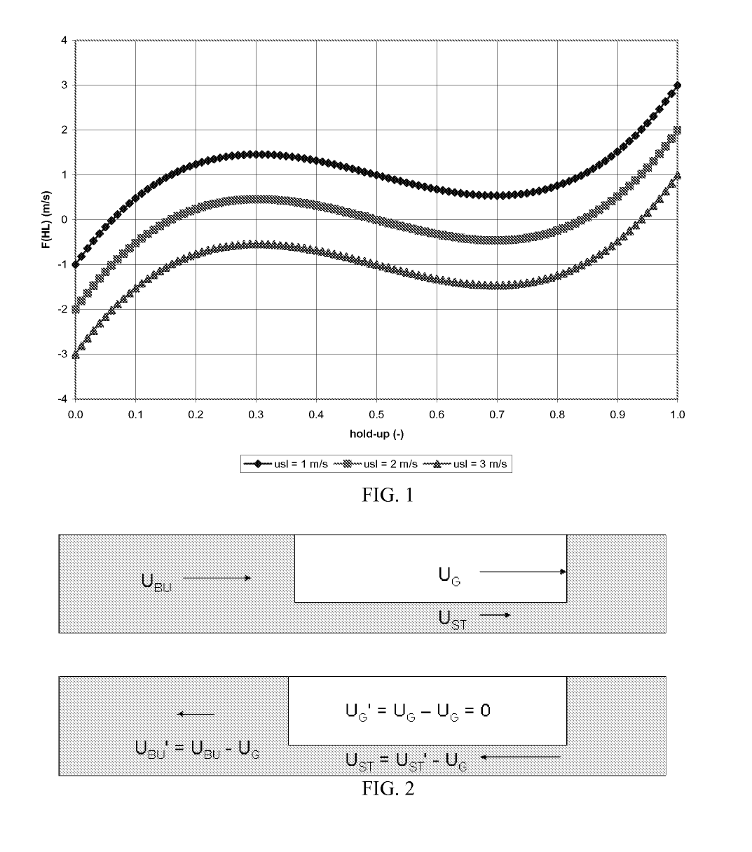

FIG. 1 gives the form of this equation for a specific A, B, U_{SL}, and U_{SG}. Note that this cubic equation has several very interesting features:
At low U_{SL}, there is only one low-hold-up, high-slip solution, which is stable;
As U_{SL} increases above a critical threshold, a two additional hold-up solutions appear—one intermediate hold-up which is unstable, and another high hold-up, low-slip solution which is stable;
As U_{SL} increases still further, the low- and intermediate hold-up solutions disappear, leaving only the single high hold-up, low-slip solution.

It is the thesis of this paper that the low hold-up solution which appears at low U_{SL} corresponds to stratified flow, and the high hold-up solution that occurs at high U_{SL} corresponds to bubble flow. At intermediate U_{SL}, there is a possibility that the low- and high-hold-up solutions will both coexist in the pipeline at the same time; this is hydrodynamic slug flow.

It should be pointed out, however, that if we invert the F(H_{L}) equation to find U_{SL}(H_{L}) as before, we obtain

U_{SL}(H_{L})=A·H_{L}³+(B−A)·H_{L}²+(U_{M}−B)·H_{L}

Let us number the three solution hold-ups which satisfy F(H_{L})=0 as H_{L1}*, H_{L2}*, and H_{L3}*. (where H_{L1}* <H_{L2}*<H_{L3}*) We obtain, at steady-state:

U_{SL}(H_{L1}*)=U_{SL}(H_{L2}*)=U_{SL}(H_{L3}*)

This is clearly not the case in slug flow, where the superficial liquid velocity in the slug body is considerably higher than that in the stratified region. This unphysical result must be rectified before we can continue.

### EXAMPLE 3

### Change of Reference Frame

Although the cubic form of F(H_{L}) has many appealing properties, there is one last step that must be addressed in order to formulate our transient slug model. While it is true that the superficial velocities in slug flow are not all equal in a reference frame that is fixed with the pipe, in a moving reference frame they can—in fact—be made to be equal. Consider FIG. 2, which shows slug flow in a fixed frame, and also from a reference frame which moves at the velocity of the gas bubble in the stratified region, U_{G}. The linear velocities in the new reference frame are:

U_{BU}′=U_{BU}−U_{G}; U_{ST}′=U_{ST}−U_{G}

Obviously, the hold-ups are not a function of reference frame; however, the superficial velocities are. This can be seen by the following:

U_{SBU}′/H_{B}=U_{SBU}/H_{B}−U_{G}→U_{SBU}′=U_{SBU}−U_{G}·H_{B}; U_{SST}′/H_{S}=U_{SST}/H_{S}−U_{G}→U_{SST}′=U_{SST}−U_{G}·H_{S}

Finally, as a consequence of the above:

U_{M}′=U_{M}−U_{G}

In the moving reference frame, U_{SBU}′=U_{SST}′=U_{M}′, by definition. The gas velocity U_{G} can be calculated from a drift-flux formulation. Let us set:

U_{G}=U_{M}+U_{O}(C=1)

Note further that:

U_{M}′=U_{M}−U_{G}=−U_{O}

Thus, U_{O} is determined from a drift-flux type relation; U_{O} is then used to obtain both U_{G} and U_{M}′. Once U_{G} is known, we can calculate the superficial velocities in the fixed-frame stratified and bubble regions by:

U_{SBU}=U_{SBU}′+U_{G}·H_{B}; U_{SST}=U_{SST}′+U_{G}·H_{S}

Lastly, it should be mentioned that the slip velocity, like the hold-up, is frame-invariant.

### EXAMPLE 4

### Hydrodynamic Slug Flow Model

In one embodiment, a simple, time-dependent, two-phase (gas-liquid) hydrodynamic slug flow model is described which is capable of producing hydrodynamic slugging from first principles. The slug model correctly predicts transition from stratified to slug flow via an interface instability. The model is capable of producing slug lengths and frequencies, as well as slug void fraction, from first principles. Also, flow regime transitions are effectively captured. The model also captures slug initiation on uphill pipe sections and slug decay on downhill sections. Because of its simplicity, the model runs extremely fast compared to other multiphase flow simulators

The hydrodynamic slug flow model can now be modeled as a function of two competing processes:
Slug formation and growth
Slug dissipation

Slug formation occurs naturally when conditions favorable for slug formation exist. This includes the existence of at least two stable solutions to the hold-up function F(H_{L}). Slug propagation is a wave-like phenomenon, with wave celerity (slug speed) equal to the gas bubble velocity U_{G}. In a fixed frame of reference, we have:

δz·d(H_{L})/dt=(U_{SL})_{IN}−(U_{SL})_{OUT}

The above equation set must be upwinded to assure stability of the solution, with the upwinding of the U_{SL} terms (which move from right). It was found that a third-order upwind scheme for the right-hand-side terms is required to combat the numerical diffusion which would otherwise destroy the slugs (Courant, et al., 1952). Finally, the pipeline is simulated as either a once-through or with periodic boundary conditions, i.e., whatever leaves out of the right-hand side of the pipeline is reintroduced to the left-hand side.

In one embodiment, we will consider the following conditions:

U_{SG}=3 m/s

U_{SL}=1 m/s

U_{M}=U_{SL}+U_{SG}=4 m/s

A drift-flux model is employed to calculate U_{O} (we take C_{O}=1) U_{O} is given by:

U_{O}=0.4·(gD)^{1/2}·((ρ_{L}−ρ_{G})/ρ_{L})^{1/2}

For a 20-inch oil pipeline at typical operating conditions, U_{O}˜1 m/s. Once U_{O} is known, the gas velocity and the the average hold-up can be calculated via the drift-flux model:

U_{O}=1 m/s

U_{G}=U_{M}+U_{O}=5 m/s

H_{L}=(U_{SL}+U_{O})/(U_{M}+U_{O})=0.4

This drift-flux hold-up is used to initialize the hold-up in the numerical simulation. The slip relation used is:

U_{S}(H_{L})=−4·H_{L}+4)>0 for all H_{L})

Here the slip velocity is taken as positive for all hold-ups.

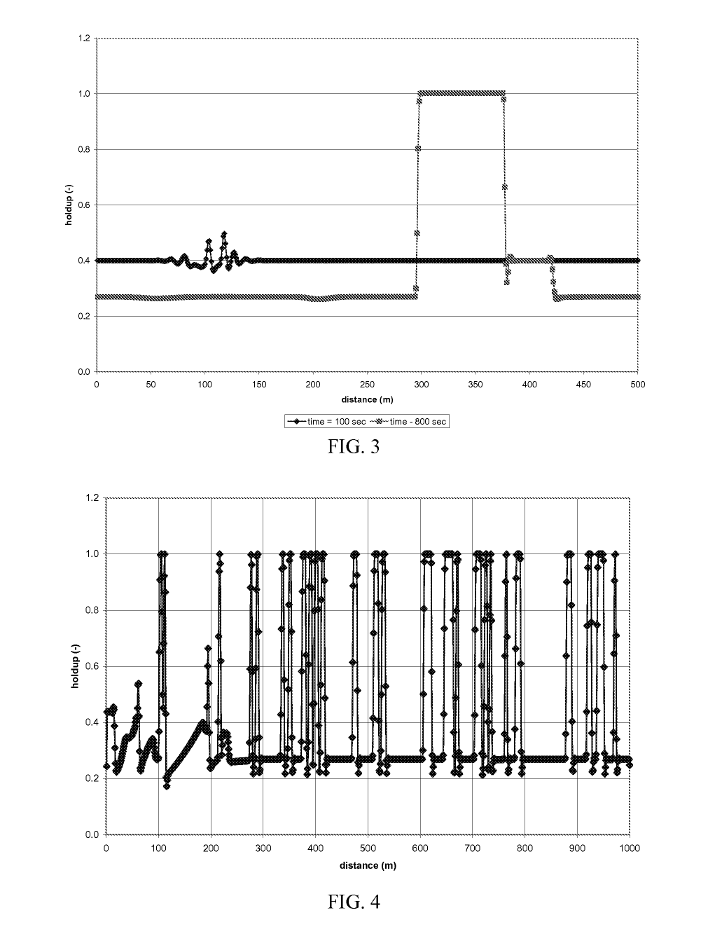

FIG. 3 shows the hold-up in a 500 m line as a function of distance along the pipeline as a function of time, using the input data given above. In this case, a periodic boundary condition is imposed, such that whatever fluid exits at the right-hand side is reintroduced at the left-hand side. The simulation is initialized at H_{L}=0.4, and the interface is perturbed with a very small perturbation (0.41 for a single computational cell was used in this case). Note that even a very small perturbation will eventually grow into a hydrodynamic slug. Owing to the third-order upwinding scheme, the slug is very stable, and once it reaches maximum size will continue to move through the domain with no apparent numerical diffusion. The hold-up in the stratified region between slugs is also maintained at H_{L}=0.27.

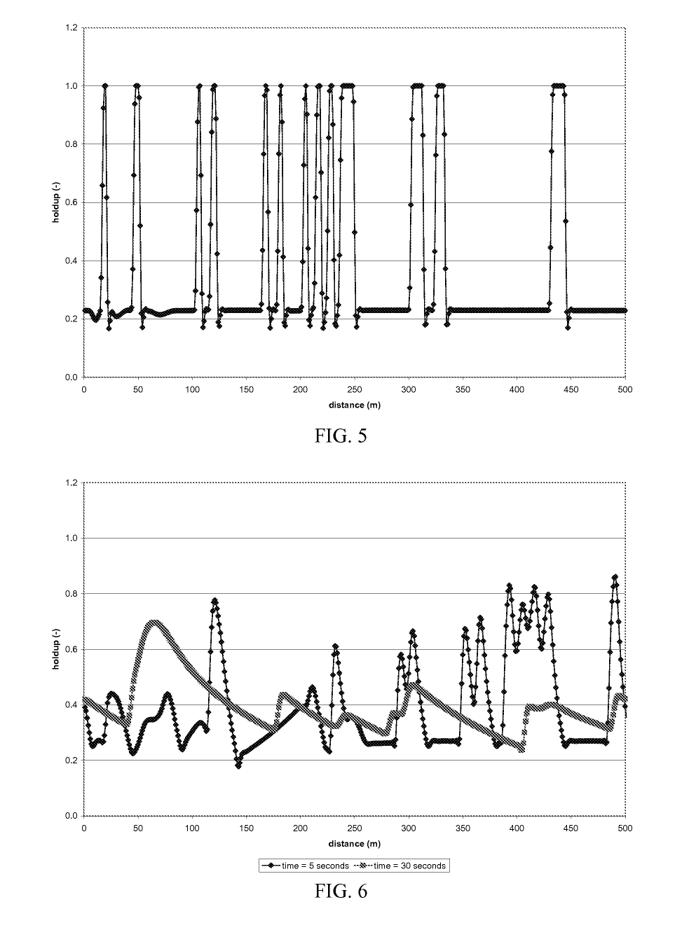

FIG. 4 gives the behavior of a 1000 m pipeline, again using the same input data as for FIG. 3. This simulation is now run as a once-through, so that slugs are born near the inlet and grow as they move through the line from left to right. A white-noise random signal of hold-ups, varying between H_{L}=[0, 0.8] is used at the inlet. As the slugs reach the end of the pipeline, the hydrodynamic slugs have resolved themselves into a more-or-less stable pattern. The longer slugs are around 10 m long (˜20 diameters), or so. FIG. 5 gives the behavior of the 1000 m pipeline, using FIG. 4 as a starting point, and continuing the simulation with periodic boundary conditions. This is meant to simulate an infinitely-long pipeline. The slugs have now completed their growth, with the longest slugs having lengths of ˜40 diameters. Finally, FIG. 6 shows the impact of the slip equation Uₛ(H_{L}). We have restarted the simulation with:

U_{S}(H_{L})=4·H_{L}−4(<0 for all H_{L})

Now the slugs disappear and drop back into stratified flow. Thus, this simple model could potentially be used to model the decay and death of slugs down pipeline declines.

### EXAMPLE 5

### Slug Formation and Dissipation

All results presented so far were for horizontal pipeline. Of course, flow regime, slip velocity, and hold-up are also a function of angle. A very simple model for inclination angle is postulated of the form:

U_{S}(θ)=U_{S}(H_{L})+f(θ)

So an increase in inclination angle above horizontal results in both a change in F′(H_{L}) and an increased hold-up. Here:

U_{SL}=0.39 m/s

U_{SG}=3.71 m/s

H_{L}=0.25 (on horizontal sections)

Using the same slip relation as Figure X-7 with an additional term to account for angle, only selective hold-ups lead to instability as demonstrate in FIG. 10. This is a once-through model, in that whatever enters the line at the inlet exits from the pipeline outlet. There is a 1-degree inclined section from 100 to 250 m, with a 100 m horizontal section at the inlet and a 250 m horizontal section at the outlet. One can see from the simulation that there are no slugs in the initial stratified region, a creation of slugs on the inclined section, and a dissipation of slugs again on the horizontal section after the incline.

### EXAMPLE 6

### Field Comparison

In order to test the model at field conditions, we have utilized Test 14 from Brill, et al. (1981). The pipeline data are given in Table 1. The pipeline was identified as being in slug flow, with the slugs following a log-normal distribution. The median slug size was measured at 400 feet (122 m), with the longest slug about three times this length at 1200 ft (366 m).

TABLE 1
Test 14 Pipeline Specifications

| | | |
|---|---|---|
| Pipeline ID | 15.312 | inch (0.3889 m) |
| Pipeline length | 14762 | feet (4500 m) |
| Q_{OIL} | 71,354 | STB/D |
| Q_{GAS} | 50,623 | Mscf/D |
| Inlet pressure | 632 | psig |
| Outlet pressure | 555 | psig |
| U_{SL} | 1.2 | m/s |
| U_{SG} | 2.9-3.2 | m/s |
| U_{O} | 0.80 | m |

Gamma densitometer readings indicated slug hold-ups of 0.60, with stratified hold-ups between the slugs of 0.20; we will adjust our model as much as it possible to match these measured results. The average hold-up is estimated at 0.4, based on the drift-flux model.

The inlet hold-up is white noise varying between H_{L}=[0.2, 0.6], such that the average hold-up into the pipeline over time matches the average pipeline hold-up. In reality, the pipeline is most likely chaotic, with inlet slug initiation being influenced by slugs exiting at the outlet over time. The pipeline model has been adjusted to maintain a slug body hold-up of 0.6; the stratified hold-up between slugs is determined by the slip relation U_{S}(H_{L}). Here we have used a quadratic slip relationship, chosen because it gave the closest fit to the field data:

U_{S}(H_{L})=6·H_{L}²−12·H_{L}+6

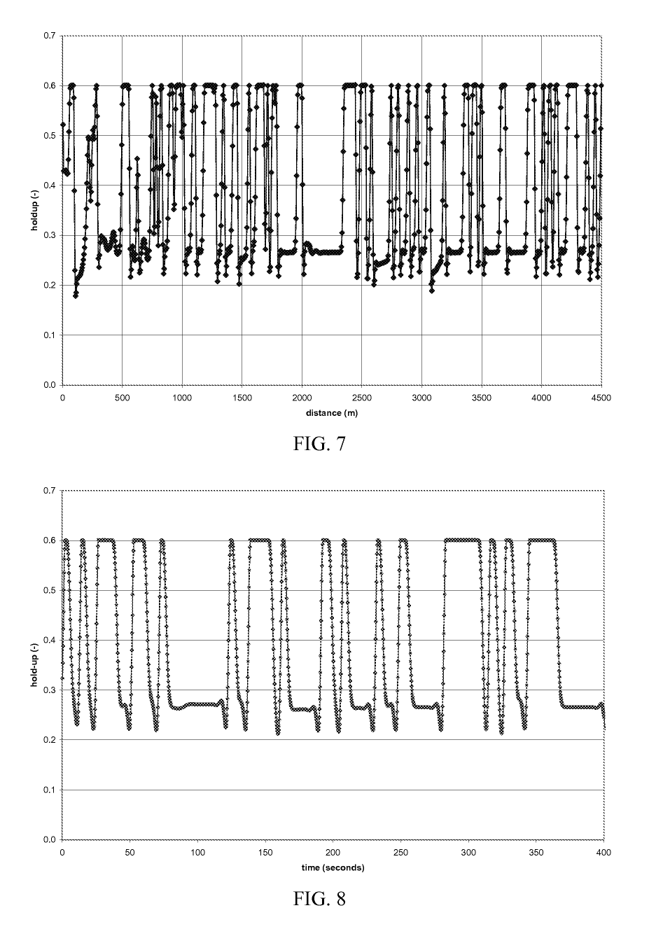

The hold-up between slugs produced by this slip relationship is 0.27—somewhat higher than the field measurement of 0.2. FIG. 7 shows the hold-up profile in the pipeline at a specific instant in time. Note that there is some consolidation of slugs in the pipeline as one moves from left (inlet) to right (outlet), and that the profile appears very realistic.

FIG. 8 gives the hold-up at the end of the line as a function of time, i.e., the time trace. Slug lengths are determined by measuring the transit time for the slugs and multiplying by the slug velocity, U_{G}=5 m/s, to obtain the slug lengths. Slugs varied in length from 45 m to 750 meters (116 to 1928 pipeline diameters). This is compared to the field measurements, which varied from 30 to 430 m (77 to 1105 pipeline diameters). It should be mentioned that the slug lengths measured in the field were much higher than the 30 diameters maximum obtained in laboratory experiments.

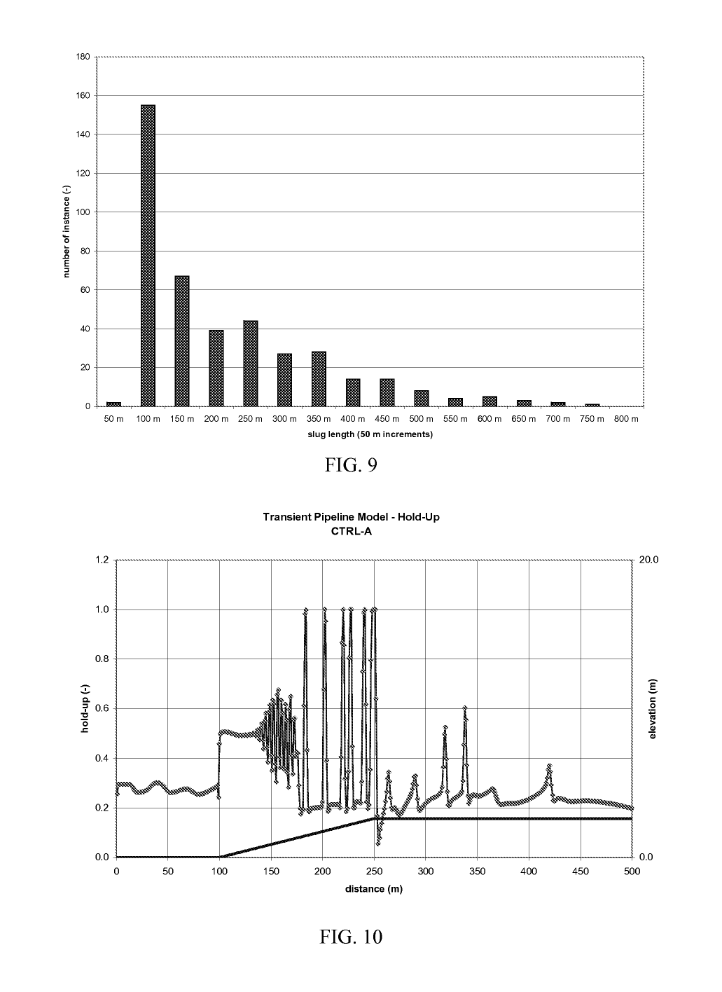

FIG. 9 presents a histogram of the number of instances of slugs of a given bin size, plotted against bin size. Median slug size predicted by the model is 100-150 m—in very good agreement with the field measurement of 120 m. The largest slug predicted by the model was a single instance in the 700-750 m bin. This was over twice as large as the largest slug measured in the field, at 430 m. This discrepancy may be due to the much larger number of slugs (about ten times as many) measured in the numerical experiments, allowing for the observation of much rarer, much larger slugs.

In closing, it should be noted that the discussion of any reference is not an admission that it is prior art to the present invention, especially any reference that may have a publication date after the priority date of this application. At the same time, each and every claim below is hereby incorporated into this detailed description or specification as a additional embodiments of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

### REFERENCES

All of the references cited herein are expressly incorporated by reference. The discussion of any reference is not an admission that it is prior art to the present invention, especially any reference that may have a publication data after the priority date of this application. Incorporated references are listed again here for convenience:
1. Beggs and Brill, “A Study of Two Phase Flow in Inclined Pipes,” J. Pet. Tech., 607-17 (1973).
2. Bendiksen, et al., “The Dynamic, Two-Fluid Model OLGA: Theory and Application,” SPE-19451, (1990).
3. Brill, et al., “Analysis of two-phase tests in large-diameter flow lines in Prudhoe Bay field”, SPE Journal, 363-378, (1981).
4. Buckingham, “On Physically Similar Systems: Illustrations of the Use of Dimensional Equations,” Phys Rev. 4:345-76 (1914).
5. Courant, et al., “On the Solution of Nonlinear Hyperbolic Differential Equations by Finite Differences,” Comm. Pure Appl. Math., 5:243-255 (1952).
6. Danielson, et al., “LEDA: The Next Multiphase Flow Performance Simulator,” BHRG Conf. Proc., Barcelona, 477-92 (2005).
7. Danielson, “Sand Transport Modeling in Multiphase Pipelines,” OTC 18691 (2007).
8. Danielson and Fan, “Relationship Between Mixture and Two-Fluid Models,” BHRG Conf. Proc., Cannes, 479-90 (2009).
9. Danielson, et al., “Testing and Qualification of a New Multiphase Flow Simulator,” OTC 21417 (2011).
10. Danielson, “Flow Assurance: A Simple Model for Hydrodynamic Slug Flow,” OTC 21255 (2011).
11. Erickson and Mai, “A Transient Multiphase Temperature Prediction Program,” SPE 24790 (1992).
12. Kreith and Black, “Basic Heat Transfer,” Harper & Row (1980).
13. Liles and Mahaffy, “TRAC-PF1: An Advanced Best Estimate Computer Program for Pressurized Water Reactor Analysis,” NUREG/CR-3567, LA-994-M5, (1984).
14. Mandhane, et al., “A Flow Pattern Map for Gas-Liquid Flow in Horizontal Pipelines,” Int. J. Multiphase Flow, 1:537-53 (1974).
15. Manolis, et al., “Average length of slug region, film region, and slug unit in high-pressure gas-liquid slug flow,” Int'l. Conf. Multiphase Flow, Lyon, (1998).
16. Micaelli, “CATHARE, An Advanced Best-Estimate Code for PWR Safety Analysis, SETh/LEML-EM/87-58.
17. Nicklin, “Two-Phase bubble flow,” Chemical Engineering Science, 17:693-702 (1962).
18. Patankar, “Numerical Heat Transfer and Fluid Flow,” Hemisphere Publishing, (1980).
19. Patankar and Joseph, “Modeling and numerical simulation of particulate flows by the Eulerian-Lagrangian approach,” Int. J. Multiphase Flow, 27(10), 1659-1684 (2001).
20. Perry and Chilton, “Chemical Engineers' Handbook,” 6th Edition, McGraw-Hill, 1984.
21. Ransom, et al., “RELAP5/MOD1 Code Manual Volume 1: System Models and Numerical Methods,” NUREG/CR-1826, EGG-2070, (1982).
22. Shenk, “Calculus and Analytical Geometry,” 2nd Edition, Goodyear Publishing, (1979).
23. Taitel and Dukler, “A Model for Predicting Flow Regime Transitions in Horizontal and Near Horizontal Gas-Liquid flow,” AICHE, 22:47-55 (1976).
24. OLGA 92 Model and Numerics Guide, Multiphase Flow Program, IFE/KR/F-91,147 (1991-1992).
25. Van Ness and Abbott, “Classical Thermodynamics of Nonelectrolyte Solutions,” McGraw-Hill, (1982)

1. A system for determining flow assurance comprising:
a) a computer readable medium comprising one or more modeling programs,
b) providing properties for one or more sections of a pipe comprising a composition with two or more phases,
c) developing a point model for at least one section of pipe given a set of physical properties for each phase present in said section of pipe,
d) connecting one or more additional sections of pipe to develop a steady-state model for a pipeline, and
e) incorporating the steady-state model into a transient scheme for modeling slug flow.

2. A method of determining flow assurance comprising:
a) providing properties for one or more sections of a pipe comprising a composition with two or more phases,
b) developing a point model for at least one section of pipe given a set of physical properties for each phase present in said section of pipe,
c) connecting one or more additional sections of pipe to develop a steady-state model for a pipeline, and
d) incorporating the steady-state model into a transient scheme for modeling slug flow.

3. A method of producing hydrocarbon containing mixtures from a subterranean formation comprising:
a) providing properties for one or more sections of a pipe comprising a composition with two or more phases,
b) developing a point model for at least one section of pipe given a set of physical properties for each phase present in said section of pipe,
c) connecting one or more additional sections of pipe to develop a steady-state model for a pipeline,
d) incorporating the steady-state model into a transient scheme for modeling slug flow, and
e) providing a flow assurance model that provides conditions for producing hydrocarbon containing mixtures from as subterranean formation without slug formation or flow impediments.

4. The method of one of claims 1 to 3, wherein said modeling is conducted by one or more software programs selected from the group consisting of ANSYS™, EOSMODEL™, GASVLE™, OILVLE™, HYSYS™, LEDAFLOW®, MULTIFLASH®, NATASHA™, NODEMODEL™, OLGA®, PIPEFLO™, PIPELINE STUDIO™, PIPESIM™, PIPESYS™PVTSIM™, REO®, WAXPRO™, XPLORE™, and the like.

5. The method of one of claims 1 to 4, wherein one or more physical properties include gas temperature (TG), liquid temperature (TL), pipe cross-sectional area (A), gas cross-sectional area (AG), liquid cross-sectional area (AL), total volumetric flow rate (Q), gas volumetric flow rate (QG), liquid volumetric flow rate (QL), gas mass fraction (ψ), fixed-frame linear liquid velocity in the slug body (UB), moving-frame linear liquid velocity in the slug body (UB′), gas linear velocity (UG), liquid linear velocity (UL), mixture velocity (UM), drift velocity (UO), slip velocity (US), fixed frame superficial liquid velocity in the slug body (USB), moving frame superficial liquid velocity in the slug body (USB′)k, gas superficial velocity (USG), liquid superficial velocity (USL), fixed-frame superficial liquid velocity in the stratified region (USS), moving-frame superficial liquid velocity in the stratified region (USS′), and the like.

6. The method of one of claims 1 to 5, wherein said point model comprises a steady state equation where:
USHL2+(UM−US)HL−USL=0

7. The method of one of claims 1 to 6, wherein slug formation is predicted through slug propagation:
z·d(HL)/dt=(USL)IN−(USL)OUT
where d(HL) is the chang in hold up function, (USL)IN is incoming liquid superficial velocity, and (USL)OUT is outgoing liquid superficial velocity.
